(19) United States
(12) Patent Application Publication
(10) Pub. No.: US 2026/0236865 A1
(43) Pub. Date: Aug. 13, 2026

(54) CONTROL METHOD AND CONTROL DEVICE FOR SMART FACTORY

(71) Applicants: Hyundai Motor Company, Seoul (KR); Kia Corporation, Seoul (KR)

(72) Inventors: Kyung Dong PARK, Gyeonggi-do (KR); Kye Un AHN, Gyeonggi-do (KR); Man Ki LEE, Gyeonggi-do (KR); Sung Hyun KIM, Gyeonggi-do (KR)

(21) Appl. No.: 19/155,677

(22) PCT Filed: Dec. 14, 2023
(86) PCT No.: PCT/KR2023/020662

§ 371 Date: Aug. 12, 2025

(30) Foreign Application Priority Data
Apr. 11, 2023 (KR) 10-2023-0047616

(51) Int. Cl. G06Q 10/0631; G05B 19/418; G05D 1/24; G05D 1/644; G05D 1/667; G05D 1/69; G05D 105/20; G05D 107/70; G05D 109/10; G06Q 10/047

(52) U.S. Cl. CPC G06Q 10/06316; G05B 19/41895; G05D 1/24; G05D 1/644; G05D 1/667; G05D 1/69; G06Q 10/047; G05D 2105/20; G05D 2107/70; G05D 2109/10

(57) ABSTRACT

A control method and a control device for a smart factory are presented, the control method comprising the steps of: determining area priority order for a plurality of parking areas; disposing a production vehicle in one parking area among the plurality of parking areas on the basis of a warehousing priority order according to production sequence information of a production management system and the area priority order; and re-disposing at least one among the production vehicles disposed in the plurality of parking areas on the basis of a shipment priority order according to customer delivery order information of a shipment management system and the area priority order.

### TECHNICAL FIELD

The present disclosure relates to a control method and a control device for a smart factory, the control method and control device being able to efficiently perform and manage processes of a smart factory.

### BACKGROUND ART

Recently, smart logistics vehicles have been introduced not only in general warehouses and factories but also in smart factories that manufacture items of different specifications using various parts in order to achieve flexible and efficient supply and transfer of parts, etc.

A smart logistics vehicle is a comprehensive concept including an autonomous mobile robot (AMR) and an automated guided vehicle (AGV), and such a smart logistics vehicle can move and perform tasks under the control of a control system.

In a smart factory where such smart logistics vehicles and a control system are applied, manufactured products can be stored and dispatched to and from designated areas using the smart logistics vehicles. For example, when a smart factory is applied to a vehicle manufacturing plant, smart logistics vehicles can store the manufactured vehicles in a collection area or dispatch the vehicles stored in the collection area.

However, the manufactured vehicles may have a storage priority or a dispatch priority, and it is necessary to propose a method for efficiently storing or dispatching vehicles on the basis of such storage priority or dispatch priority.

The description provided above as a related art of the present disclosure is just for helping understand the background of the present disclosure and should not be construed as being included in the related art known by those skilled in the art.

### DISCLOSURE

### Technical Problem

An objective of the present disclosure is to provide a control method and a control device for a smart factory that can efficiently perform the storage and dispatch of manufactured vehicles using smart logistics vehicles.

The technical subjects to implement in the present disclosure are not limited to the technical problems described above and other technical subjects that are not stated herein will be clearly understood by those skilled in the art from the following specifications.

### Technical Solution

A control method for a smart factory according to the present disclosure for achieving the objectives may include: determining area priorities for a plurality of parking areas; placing a manufactured vehicle to one parking area of the plurality of parking areas on the basis of storage priorities according to manufacturing sequence information of a production management system and the area priorities; and relocating at least one of manufactured vehicles placed in the plurality of parking areas on the basis of dispatch priorities according to customer delivery order information of a dispatch management system and the area priorities.

Further, a control device for a smart factory according to the present disclosure for achieving the objectives may include: a parking management part configured to determine area priorities for a plurality of parking areas and configured to create control information for at least one smart logistics vehicle such that a manufactured vehicle is placed in one parking area of the plurality of parking areas on the basis of storage priority according to manufacturing sequence information of a production management system and the area priorities or such that at least one of manufacture vehicles placed in the plurality of parking areas is relocated on the basis of dispatch priority according to customer delivery information of a dispatch management system and the area priorities; and a communication part configured to transmit the control information to the at least one smart logistics vehicle.

### Advantageous Effects

According to the control method and control device for a smart factory of the present disclosure, by placing manufactured vehicles on the basis of the storage priorities of the manufactured vehicle or the area priorities of parking areas when manufactured vehicles are stored, or relocating manufactured vehicles on the basis of the dispatch priorities of manufactured vehicles or the area priorities of parking areas, it is possible to efficiently store and dispatch manufactured vehicles using at least one of a plurality of smart logistics vehicles.

The effects of the present disclosure are not limited to the effects described above and other effects can be clearly understood by those skilled in the art from the following description.

### DESCRIPTION OF DRAWINGS

FIG. 1 is a block diagram showing an example of the configuration of a smart factory that can be applied to embodiments of the present disclosure.

FIG. 2 is a block diagram showing an example of the configuration of a control device that can be applied to embodiments of the present disclosure.

FIG. 3 is a block diagram showing an example of the configuration of smart logistics vehicle that can be applied to embodiments of the present disclosure.

FIG. 4 is a perspective view showing an example of the external appearance of a smart logistics vehicle that can be applied to embodiments of the present disclosure.

FIG. 5 is a block diagram showing the configuration of Smart factory control system according to an embodiment of the present disclosure.

FIG. 6 is a block diagram showing the configuration of a parking management part that manages placement and relocation of manufactured vehicles in accordance with an embodiment of the present disclosure.

FIG. 7a to FIG. 7b are diagrams schematically illustrating parking areas in which manufactured vehicles are placed in accordance with an embodiment of the present disclosure.

FIG. 8 to FIG. 10 are diagrams illustrating a smart factory control method according to an embodiment of the present disclosure.

### MODE OF INVENTION

In the following description, if it is decided that the detailed description of known technologies related to the present disclosure makes the subject matter of the embodiments described herein unclear, the detailed description is omitted. Further, the accompanying drawings are provided only for easy understanding of embodiments disclosed in the specification, the technical spirit disclosed in the specification is not limited by the accompanying drawings, and all changes, equivalents, and replacements should be understood as being included in the spirit and scope of the present disclosure.

Terms including ordinal numbers such as “first” and “second” may be used to describe various components, but the components are not to be construed as being limited to the terms. The terms are used only to distinguish one component from another component.

It should be understood that when one element is referred to as being “connected to” or “coupled to” another element, it may be connected directly to or coupled directly to another element or be connected to or coupled to another element with the other element therebetween. On the other hand, it should be understood that when one element is referred to as being “connected directly to” or “coupled directly to” another element, it may be connected to or coupled to another element without other elements therebetween.

Singular forms are intended to include plural forms unless the context clearly indicates otherwise.

It will be further understood that the terms “comprise” or “have” used in this specification specify the presence of stated features, steps, operations, components, parts, a combination thereof, but do not preclude the presence or addition of one or more other features, numerals, steps, operations, components, parts, or a combination thereof.

Hereafter, embodiments of the present disclosure will be described in detail with reference to the accompanying drawings and the same or similar components are given the same reference numerals regardless of the numbers of figures and are not repeatedly described.

A unit or a control unit included in the internal configuration names of a smart logistics vehicle or a control device is only a term that is generally used to name a controller that controls specific functions rather than mean a generic function unit. For example, each controller may include a modem/transceiver that communicates with another controller or a sensor to control corresponding functions, a memory that stores an operating system or logic commands and input/output information, and one or more processors that perform determination, calculation, decision, etc. for controlling the corresponding functions. Depending on implementation, one processor may be in charge of computation of a plurality of controllers.

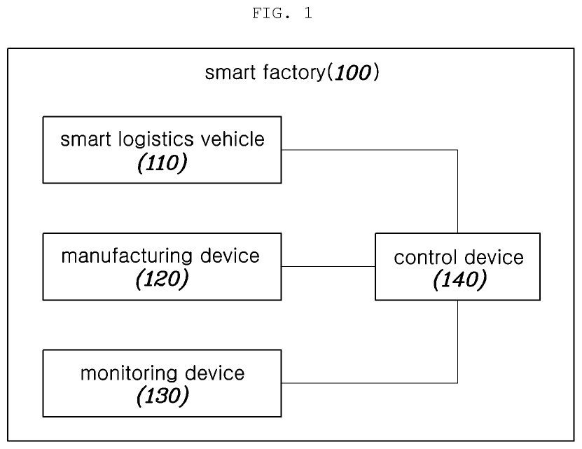

First, the configuration of a smart factory in which smart logistics vehicles according to an embodiment of are deployed and operated is described with reference to FIG. 1.

FIG. 1 is a block diagram showing an example of the configuration of a smart factory that can be applied to embodiments of the present disclosure.

Referring to FIG. 1, a smart factory 100 may include a smart logistic vehicle 110, a manufacturing device 120, a monitoring device 130, and a control device 140.

The smart factory 100 may include a plurality of smart logistics vehicles 110, a plurality of manufacturing devices 120, and a plurality of monitoring devices 130, depending on the manufacturing process and the target manufacturing speed for products. Hereafter, the components are described.

First, the smart logistics vehicle 110 may include an Autonomous Mobile Robot (hereinafter referred to as “AMR” for convenience) and an Automated Guided Vehicle (hereinafter referred to as “AGV” for convenience). Only one type of AGV or AMR may be operated in accordance with the operation policy of the smart logistics vehicle 110 in the smart factory 100, and AGV and AMR both may be operated in a single smart factory 100.

An AGV generally performs required operations (such as movement, direction change, and stop) in the smart factory 100 by recognizing and following guiding facilities installed on the floor for guiding the AGV. In this configuration, the guide facilities may refer to a marker (a spot, a 2D code, etc.) that can be optically recognized, a tag (e.g., an NFC tag, an RFID tag, etc.) that can be recognized in a non-contact type at a short distance, a magnetic strip, a wire, etc., but these are examples and the present disclosure is not necessarily limited thereto. The guide facilities may be continuously disposed or discontinuously spaced apart from each other on a floor. AGVs require that guide facilities have been installed in advance before application because they basically perform operations by recognizing and following guide facilities, so when it is required to move an AGV to a new path or change an existing path, it is required to install new facilities or physically change existing guide facilities. Further, since AGVs do not depart from a path set through guide facilities, when an obstacle is sensed on or around a path, AGVs generally stop until the object is removed or they are specifically controlled. In order to operate an AGV, the control device 140 should control the AGV on the basis of guide facilities, so the control device 140 can transmit instructions stating “drive until recognizing a third marker”, “turn 90 degrees when recognizing a third marker”, etc. to the AGV at the current location in the unit of individual instruction or in the unit of mission including a plurality of instructions (e.g., retrieving, supplying, charging, patrolling, etc.).

An AMR can determine the current location (i.e., positioning) by sensing the surrounding and it can be considered as the most distinguishable point from an AGV that an AMR can plan a path by itself by positioning and using a map. Accordingly, when a map in which coordinates are compatible is shared between the AMR and the control device 140, the control device 140 can control the AMR by instructing the AMR with a path on the basis of coordinates. Further, when an obstacle is sensed during driving, an ARM can return after avoiding the obstacle by setting an avoidance path by itself. The function of the control device 140 setting one or more passing-through coordinates as the path of an AMR can be referred to as global path planning and the function of an AMR setting a movement path or an avoidance path between passing-through coordinates determined by global path planning can be referred to as local path planning.

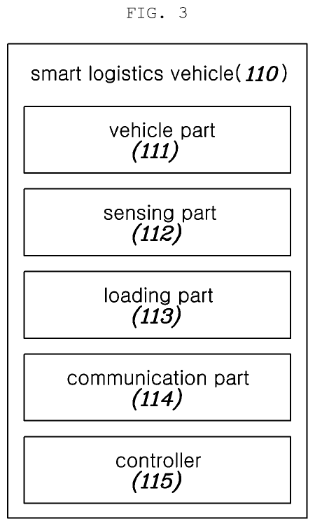

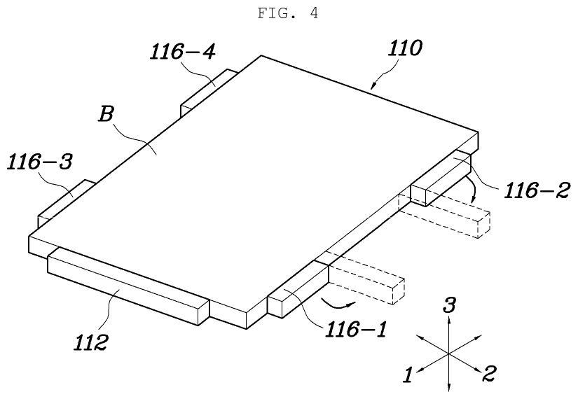

The more detailed configuration of the smart logistics vehicle 110 is described below with reference to FIG. 3 and FIG. 4.

Next, the manufacturing device 120 may refer to a device (e.g., a robot arm, a conveyor belt, etc.) that performs a manufacturing process of products in the smart factory 100, and in a broader sense, may refer to a device disposed to assist in performing missions such as the entry and exit of the smart logistics vehicle 110 when the manufacturing process is performed by humans. The device disposed to assist in execution of missions may be a device that monitors the state of a designated position where the smart logistics vehicle 110 can put down pallets carried thereon or can pick pallets in an area in which a specific manufacturing process is performed, a device that determines the progress of a process, a device that manages entry and exist in an area, etc., but the device is not limited thereto.

For example, the manufacturing device 120 can be controlled through a Programmable Logic Controller (PLC) and can communicate with the control device 140 in connection with the progress of a process.

The monitoring device 130 can perform a function of acquiring information for determining the situation in the smart factory 100 and transmitting the information to the control device 140. For example, the monitoring device 130 may include a camera, a proximity sensor, etc., but is not necessarily limited thereto.

The control device 140 communicates with the components 110, 120, and 130 described above, thereby being able to acquire information for operating the smart factory 100 or control the components. For example, the control device 140 can perform dispatching of the smart logistics vehicle 110, route planning, mission assignment, product-specific process management, material management, etc.

In an embodiment, the control device 140 may include a local control device (AMR/AGV Control System (ACS)) that controls surrounding process facilities on the basis of the location of an AGV/AMR and controls the AGV/AMR on the basis of a mission, and an integrated control device (Mobile Robot Integrated Monitoring System (MoRIMS)) that integrally controls two or more local control devices. The integrated control device can control the states and paths of all smart logistics robots 110 in the smart factory 100, sets logistic flow, and control traffic in cooperation with a plurality of local control devices. For example, when the local control device (ACS) is provided for smart logistics robots of a same manufacturer or a same kind, the integrated control device can perform integrated control for preventing a collision such as analysis of a bottleneck level in intersecting/overlapping areas, acceleration/deceleration control in driving, recreation of an avoidance path through traffic distribution control between different kinds on the basis of information acquired through a plurality of local control devices (ACS).

Further, the integrated control device can also have a Manufacturing Execution System (MES) as an upper control subject and the MES can be linked with an automated scheduler (Advanced Planning & Scheduling (APS).

Other than the components 110, 120, 130, and 140 of the smart factory 100 described above, a device for communication between components such as an Access Point (AP), a charger for charging the smart logistics vehicle 110, a loading space for storing or loading parts, a space where finished products or intermediate products are kept, a traffic signal, a barrier gate, a waiting space for idle smart logistics vehicles 110, etc. may also be appropriately disposed in the smart factory 100.

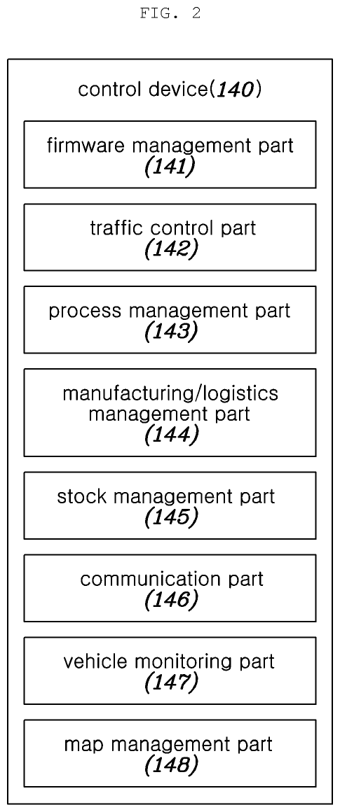

Hereafter, the configuration of the control device 140 that can be applied to embodiments of the present disclosure is described with reference to FIG. 2.

FIG. 2 is a block diagram showing an example of the configuration of a control device that can be applied to embodiments of the present disclosure. The components shown in FIG. 2 are components related to embodiments of the present disclosure, and more or less components may be included to actually implement the control device 140.

Referring to FIG. 2, the control device 140 may include a firmware management part 141, a traffic control part 142, a process management part 143, a manufacturing/logistics management part 144, a stock management part 145, a communication part 146, a vehicle monitoring part 147, and a map management part 148.

The firmware management part 141 can acquire the latest firmware of the smart logistics vehicle 110 through the communication part 146, transmit it to the smart logistics vehicle 110 such that a firmware is updated, thereby being able to maintain the firmware of the smart logistics vehicle 110 up to date.

The traffic control part 142 controls traffic signals and barrier gates on the basis of the path of the smart logistics vehicle 110 and can also recalculate the path of the smart logistics vehicle 110, depending on traffic.

The process management part 143 can define product-specific processes and can manage missions such as process progress and current position.

The manufacturing/logistics management part 144 can deploy smart logistics vehicles 110 on the basis of missions.

The stock management part 145 manages the location and quantity of materials, and this information can be useful for more efficient process operations, such as dispatching the smart logistics vehicle 110 to a destination ahead of the actual detection of assembly/consumption of materials, for pallet pickup or retrieval.

The communication part 146 can communicate with not only internal components of the smart factory 100 such as the smart logistics vehicle 110, the manufacturing device 120, and the monitoring device 130, but external objects such as a firmware update server.

The vehicle monitoring part 147 can monitor the location, path, battery state, communication state, powertrain state, etc. of individual smart logistics vehicle 110. In this case, the path is a concept including a waypoint-based global path and a real-time local path. Further, the battery state may include voltage, current, temperature, peak values of voltage and current, State Of Charge (SOC), State Of Health (SOH), etc. The communication state may include information about a currently active communication protocol (Wi-Fi, etc.), a connected AP, the distance from an AP, a channel being used, etc. The powertrain state may include load, temperature, RPM, etc. in a driving system.

Further, the vehicle monitoring part 147 can also check the currently assigned mission, an operation mode, a firmware version, etc., of individual smart logistics vehicle 110.

The map management part 148 can acquire map data of a grid map type, which an AMR that is a smart logistics vehicle 110 acquired while driving in the smart factory 100, and can provide a factory manager with a tool enabling the factory manager to edit the acquired map data. It is possible to set zones where a smart logistics vehicle 110 performs one or more preset operations when entering the zone, virtual lanes, intersections, no entry zones, etc. by editing the map data, but this is an example and the present disclosure is not necessarily limited thereto. The map management part 148 can distribute the map to smart logistics vehicles 110 other than the smart logistics vehicle 110, which initially actually acquired the grid map during driving, through the communication part 146.

Next, a smart logistics vehicle is described with reference to FIG. 3 and FIG. 4.

FIG. 3 is a block diagram showing an example of the configuration of a smart logistics vehicle that can be applied to embodiments of the present disclosure.

Referring to FIG. 3, the smart logistics vehicle 110 may include vehicle part 111, a sensing part 112, a loading part 113, a communication part 114, and a controller 115. Hereafter, the components are described.

The vehicle part 111 may include a driving source, wheels, a suspension, etc. involved with moving, steering, and stopping of the smart logistics vehicle 110. An electric motor that is supplied with power from a built-in battery (not shown) can be used as the driving source. The wheels may include one or more driving wheels that are supplied with driving force from the driving source and non-driving wheels that are rotated by movement of the vehicle body without being supplied with driving force. Depending on embodiments, when a plurality of driving wheels is provided, a driving source can be matched with each of the driving wheels and rotation of the driving wheels can be independently controlled. In this case, it is possible to steer by turning the vehicle body even without a specific steering system by making the rotation directions of different driving wheels different. At least some non-driving wheels may be caster-type wheels, but this is an example and the present disclosure is not necessarily limited thereto.

The sensing part 112, which is for sensing the environment of the smart logistics vehicle 110, the operation state the vehicle body, or the like, may include at least one of a 2D laser scanner (e.g., LiDAR), a 3D vision (stereo) camera, a multi-axial gyro sensor, an acceleration sensor, a wheel encoder, and a proximity sensor.

The encoder can output information that makes it possible to determine how much a wheel has rotated using light emitted from a light emitting device (e.g., a photo diode). For example, the encoder can count the number of slits circumferentially disposed on a wheel or a disc rotating with the wheel for a unit time. The controller 115 can perform odometry that estimates displacement by analyzing the amount of position variation to time using data acquired through the encoder and the gyro sensor. However, displacement estimated on the basis of encoder data may be different from actual displacement due to a slip or wear of a wheel (variation of the dynamic radius of a wheel). Accordingly, when performing odometry, the controller 115 can output a result that have a tendency closer to an actual value by performing noise and error correction through a predetermined algorithm (e.g., an Extended Kalman Filter (EKF)) using information collected from the wheels and the gyro sensor. Such odometry can be particularly useful when localization using a 2D laser scanner to be described below is not possible.

A 2D laser scanner can scan the surrounding environment by emitting a laser to the surroundings through a rotating mirror and sensing signals reflected back. In this case, it is possible to output the result of sensing a point cloud shape by analyzing the intensity of the reflected signals and the time difference between emission and reception.

A 3D vision camera can calculate the distance to an object on the basis of the disparity between two cameras spaced a certain distance apart, that is, the pixel distance between images captured through the cameras. In this case, a texture projector that emits infrared light with a predetermined pattern may be provided to be able to sense even flat objects with the same color (e.g., white walls).

In general, 2D laser scanners are used for mapping, navigation, and object recognition, while 3D cameras can be used in navigation, particularly for obstacle avoidance, but this is an example and not necessarily limited to these uses.

The loading part 113 is a part for loading items to be transported, and can be in the form of the top plate itself of the vehicle body, a table disposed on the top plate, a turntable rotating around a vertical axis, a forklift, a conveyor, or a combination thereof. The forklift may support telescopic and tilting functions similar to common forklifts.

The communication part 114 can communicate with other components in the smart factory 100 such as the manufacturing device 120 and the control device 140, can support even communication between smart logistics vehicles 110, and can communicate even with a charger when the mission of charging is performed.

The controller 115, which is a subject that generally controls the components 111, 112, 113, and 114 described above, can determine a current mission, a current location, and a destination, plan a path, control the loading part, etc. on the basis of information acquired from the control device 140 through the communication part 114.

FIG. 4 is a perspective view showing an example of the external appearance of a smart logistics vehicle that can be applied to embodiments of the present disclosure.

Referring to FIG. 4, an exemplary AMR is shown as a smart logistics vehicle 110.

The smart logistics vehicle 110 according to an embodiment of the present disclosure can be used to transport manufactured vehicles, and particularly can transport manufactured vehicles by entering under the vehicle body of the manufactured vehicles. To this end, the vehicle body B of the smart logistics vehicle 110 may, overall, have a long axis extending along first direction and may have a flat planar shape with a low height. However, this is merely an example, and it is of course possible that the shape of the vehicle body B of the smart logistics vehicle 110 is not necessarily limited thereto.

Though not shown in FIG. 4, a plurality of driving wheels may be disposed beneath the vehicle body B. The plurality of driving wheels may enable the smart logistics vehicle 110 to travel forward or backward along the first axis direction or to travel laterally along the second axis direction. Further, it may be possible to make the vehicle body B itself rotate around the third axis direction by making the rotation directions of the plurality of driving wheels different.

Further, the sensing part 112 may be disposed on the front of the vehicle body B and a plurality of clamps 116-1, 116-2, 116-3, and 116-4 may be disposed on both sides of the vehicle body B. The plurality of clamps 116-1, 116-2, 116-3, and 116-4 may be embedded in both sides of the vehicle body B in the first axis direction, and when the smart logistics vehicle 110 enters under the vehicle body of a manufactured vehicle to transport the manufactured vehicle, the plurality of clamps 116-1, 116-2, 116-3, and 116-4 can be deployed in the second axis direction. For example, the smart logistics vehicle 10 is responsible for the front or rear axle of a manufactured vehicle, whereby it can move to the front or rear axle and deploy the plurality of clamps 116-1, 116-2, 116-3, and 116-4 embedded along the first axis direction to the second axis direction, and can lift the wheels disposed on both sides of the front or rear axle using the plurality of clamps 116-1, 116-2, 116-3, and 116-4 deployed in the second axis direction. As the wheels are lifted, the manufactured vehicle is spaced a predetermined distance from the ground, and the smart logistics vehicle 110 can transport the manufactured vehicle. In this case, a plurality of smart logistics vehicle that is responsible for the front wheels and the rear wheels, respectively, may be required to transport one manufactured vehicle. Further, the smart logistics vehicle responsible for the front wheels and the smart logistics vehicle responsible for the rear wheels can transport the manufactured vehicle to a desired location through cooperative control.

However, the form and function of the AGV in FIG. 4 described above are exemplary and are not necessarily limited thereto. For example, the AMR may have a similar form and function, or the AGV may have a form different from the above description.

An objective of the present disclosure is to ensure efficient inbound or outbound of manufactured vehicles in a factory in accordance with priorities when the manufactured vehicles are stored or dispatched, using the smart logistics vehicle 110 and the control system described above.

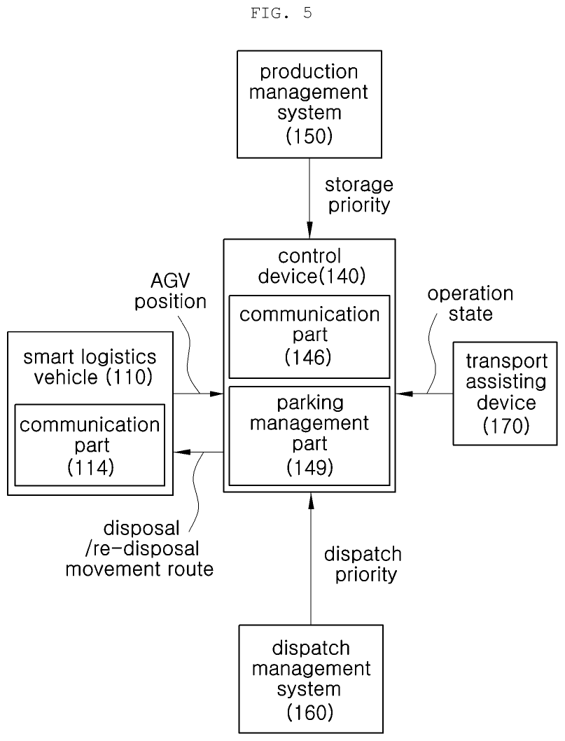

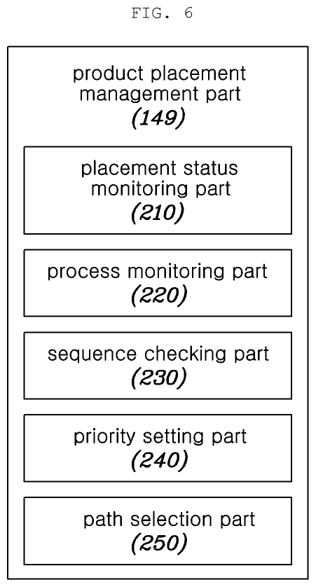

Hereafter, a smart factory control system according to an embodiment of the present disclosure is described with reference to FIG. 5 to FIG. 6.

FIG. 5 is a block diagram showing the configuration of a smart factory control system according to an embodiment of the present disclosure.

Referring to FIG. 5, a smart factory control system according to an embodiment of the present disclosure may include a smart logistics vehicle 110, a control device 140, a production management system 150, a dispatch management system (shipment management system) 160, and a transport assisting device 170. For example, the smart factory 100 may be composed of processes of manufacturing vehicles and, a vehicle manufactured through these processes is referred to as a manufactured vehicle in the following description. Further, the smart factory control system of the present disclosure assumes that a plurality of smart logistics vehicles 110 is provided.

The control device 140 may have, as input information, storage priorities (warehousing priority orders) and dispatch priorities (shipment priority orders) of manufactured vehicles provided from the production management system 150 and the dispatch management system 160. Storage priorities based on manufacturing sequence information of manufactured vehicles may be set in advance in the production management system 150, and dispatch priorities of manufactured vehicles based on customer delivery order information may also be set in advance in the dispatch management system 160. However, this is exemplary and it is of course possible that various factors other than those described above may be considered when setting the storage priority or dispatch priority.

Further, the control device 140 can be provided with storage priority or dispatch priority from the production management system 150 or the dispatch management system 160 only when a vehicle is stored or dispatched. However, this is exemplary and the control device 140 may be continuously provided with information from the production management system 150 and the dispatch management system 160 to check the storage priorities and dispatch priorities of manufactured vehicles.

Further, the control device 140 can receive the location information of the smart logistics vehicles 110 such as AGV and AMR.

The control device 140 can create movement paths for placing manufactured vehicles in parking areas when the manufactured vehicles are stored, as control information for the smart logistics vehicles 110, on the basis of the input information, or movement paths for relocating the manufactured vehicles for easy dispatch, as control information for the smart logistics vehicles 110, on the basis of the input information, and provide it to the smart logistics vehicles 110.

Meanwhile, the parking areas in which manufactured vehicles that are placed or kept after stored in the smart factory 100 may be formed as a single floor with the area where vehicles s are manufactured, or may be formed as a plurality of floors separated from the area where vehicles are manufactured. For example, in the case of a smart factory 100 with three floors, the first floor may be an area where manufactured vehicles are dispatched, the second floor may be an area where vehicles are manufactured, and the third floor may be an area where manufactured vehicles are stored and placed. However, this is exemplary, and the areas constituting the smart factory 100 may be formed in various ways, and the areas may be separately formed in one layer, if necessary.

As described above, when a plurality of areas is formed in one smart factory 100, the smart factor 100 may be provided with a transport assisting device 170 for separating the plurality of areas. Accordingly, the controller 140 may have operation state information from the transport assisting device 170 as input information. In this configuration, the transport assisting device 170 may include at least one of a smart automatic door device, and a lift and an elevator that can move between floors. However, this is exemplary, and the transport assisting device 151 may further include various devices other than the devices described above.

Further, a plurality of transport assisting devices 170 may be provided, depending on the operational situation of the smart factory 100. For example, in the case of a smart factory 100 that performs storage and dispatch operations simultaneously, a plurality of transport assisting devices may be provided separately for exclusive use in storage of manufactured vehicles and for exclusive use in dispatch of manufactured vehicles.

Meanwhile, the control device 140 may output call information for the transport assisting device 170 when the transport assisting device 170 is required, on the basis of the operation state information of the transport assisting device 170.

Hereafter, the detailed function of the control device 140 is described. The control device 140 according to an embodiment of the present disclosure may include a communication part 146 and a parking management part 149.

First, the communication part 146 may be provided with storage priorities and dispatch priorities of manufactured vehicles through communication with the production management system 150 and the dispatch management system 160 provided in the smart factory 100 according to the embodiment of the present disclosure. Further, if necessary, it may receive the operation state of the transport assisting device 170.

Further, the communication part 146 can also communicate with the communication part 114 of the smart logistics vehicle 110, and accordingly, it can check the location of the smart logistics vehicle 110 or transmit control information created by the parking management part 149.

The communication part 146 can transmit the input information to the parking management part 149, and the parking management part 149 can create control information for the smart logistics vehicle 110 when the smart logistics vehicle 110 places a manufactured vehicle on the basis of the information received from the communication part 146. The function of the parking management part 149 is described with reference to FIG. 6.

FIG. 6 is a block diagram showing the configuration of a parking management part that manages placement and relocation of manufactured vehicles in accordance with an embodiment of the present disclosure.

The parking management part 149 according to the present disclosure can determine area priorities for a plurality of parking areas, and can create control information for at least one smart logistics vehicle such that a manufactured vehicle is placed in one parking area of the plurality of parking areas on the basis of storage priority according to manufacturing sequence information of the production management system and the area priorities or such that at least one of the manufacture vehicles placed in the plurality of parking areas is relocated on the basis of dispatch priority according to customer delivery information of the dispatch management system and the area priorities.

To this end, referring to FIG. 6, the parking management part 149 may include a placement status monitoring part 210, a process monitoring part 220, a sequence checking part 230, a priority setting part 240, and a path selection part 250. However, this is exemplary and the parking management part 149 may include more or less components than the stated components. Hereafter, the components are described in detail.

The placement status monitoring part 210 can monitor a plurality of parking areas in which manufactured vehicles are stored and placed. Further, the placement status monitoring part 210 may group and monitor a plurality of parking areas with the same arrangement direction or the same area size in consideration of the arrangement direction or area size of each of the plurality of parking areas.

The process monitoring part 220 monitors the process area in which vehicles are manufactured, and can measure the size of manufactured vehicles using cameras or sensors installed in the process area.

The sequence checking part 230 can check the sequence of manufactured vehicles to be stored or dispatched on the basis of the manufacturing sequence information of manufactured vehicles provided from the production management system 150 or the dispatch priorities according to customer delivery requests provided from the dispatch management system 160.

The priority setting part 240 can receive information about a plurality of parking areas monitored by the placement status monitoring part 210, size measurement information of the manufactured vehicles measured by the process monitoring part 220, and the storage and dispatch priorities of manufactured vehicles checked by the sequence checking part 230.

Further, priority setting part 240 can determine the area priorities for the plurality of parking areas on the basis of the provided information. In this case, the area priority can be set for each of the plurality of parking areas on the basis of the distance between the entrance/exit of the space where the plurality of parking areas is provided and the plurality of parking areas.

The priority setting part 240 can select one parking area, in which a manufactured vehicle will be placed, from the plurality of parking areas on the basis of the storage priority according to manufacturing sequence information of the production management system 150 and area priority. Further, the priority setting part 240 can select one or more relocation target vehicles that need to be relocated from the plurality of manufactured vehicles placed in the plurality of parking areas on the basis of the dispatch priority according to the customer delivery order information of the dispatch management system 160 and the area priority for each of the plurality of parking areas, and can select parking areas in which the one or more relocation target vehicles will be relocated, respectively, from the plurality of parking areas. In particular, the priority setting part 240 may select, as relocation parking areas, parking areas corresponding to area priorities that match dispatch priorities assigned to one or more relocation target vehicles among the plurality of parking areas. However, this is exemplary and the present disclosure is not necessarily limited thereto.

Further, the priority setting part 240 can allow one or more relocation target vehicles to be relocated to the selected parking areas, respectively. For example, the priority setting part 240 can relocate any one of one or more relocation target vehicles, whose dispatch priority corresponds to the highest dispatch order, to a dispatch staging area corresponding to the highest area order among the plurality of parking areas.

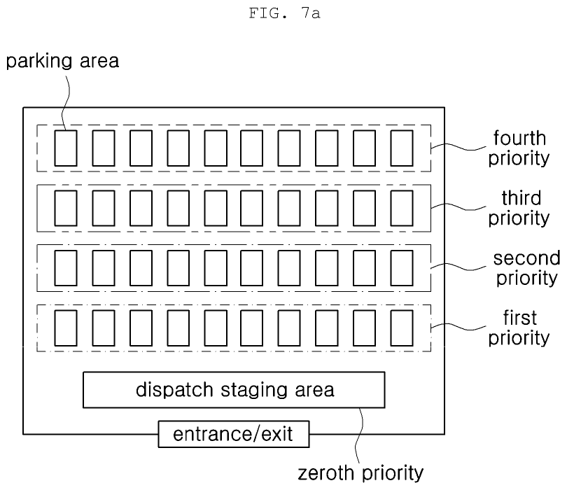

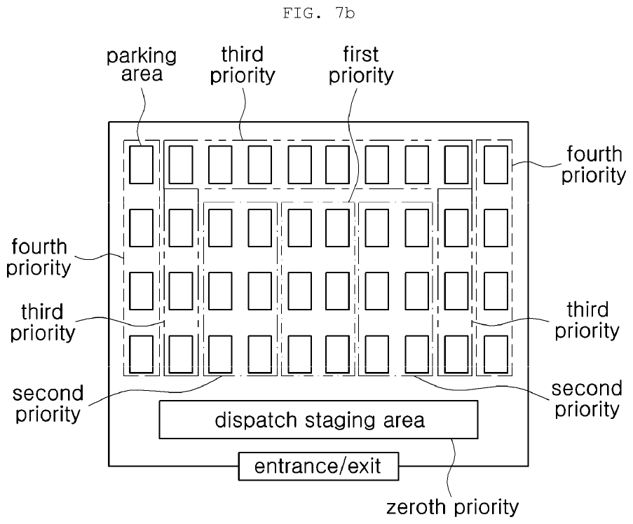

Hereafter, the plurality of parking areas described above is described with reference to FIG. 7a and FIG. 7b.

FIG. 7a to FIG. 7b are diagrams schematically illustrating parking areas in which manufactured vehicles are placed in accordance with an embodiment of the present disclosure.

First, referring to FIG. 7a to 7b, as an embodiment of the present disclosure, it is assumed that a space in which manufactured vehicles are placed exists, and the space is composed of a plurality of parking areas. An area priority can be set for each of the plurality of parking areas on the basis of the distance between the entrance/exit of the space where the plurality of parking areas is provided and the plurality of parking areas. In detail, a straight-line distance from an entrance/exit to each parking area may be calculated, and by comparing the calculated straight-line distances, higher area priorities may be set for parking areas that are close, and low area priorities may be set for parking areas that are far. For example, for a plurality of parking areas, the area closest to the entrance/exit may be set as the first priority, and the area farthest from the entrance/exit may be set as the fourth priority

Further, parking areas with the same arrangement direction or the same area size may be grouped by considering the arrangement direction or area size of each of the plurality of parking areas, and area priorities may be set for the grouped plurality of parking areas. In this case, the area priorities in the grouped plurality of parking areas may be the same. However, this is exemplary and the present disclosure is not necessarily limited thereto.

Meanwhile, a dispatch staging area, which is separated from the plurality of parking areas, may be formed near the entrance/exit of the space where the plurality of parking areas is provided. The dispatch staging area may be an area for placing a manufactured vehicle having the highest dispatch order among the dispatch priorities according to customer delivery request information among the manufactured vehicles placed in the plurality of parking areas. When a manufactured vehicle is stored and placed, the dispatch staging area may not be taken into consideration, but when a placed manufactured vehicle is to be relocated, it may be relocated in consideration of the dispatch staging area.

Further, the dispatch staging area may have the highest area priority that corresponds to a higher order than the area priorities assigned to the plurality of parking areas. For example, when the first to fourth priorities are assigned to a plurality of parking areas, respectively, the dispatch staging area may be assigned the highest priority, that is, the zeroth priority higher than the first to fourth priorities of the plurality of parking areas. Accordingly, when relocating manufactured vehicles, it is possible to relocate the manufactured vehicle of which the dispatch priority has the highest dispatch order to the dispatch staging area, and a manufactured vehicle positioned in the dispatch staging area is dispatched through the entrance/exit, whereby dispatch of manufactured vehicles can be smoothly processed.

The priority setting part 240, as shown in FIGS. 7a to 7b, can select parking areas to place or relocate manufactured vehicles on the basis of the area priorities that are set differently for a plurality of parking areas. The priority setting part 240 according to an embodiment of the present invention can select a parking area where a manufactured vehicle is to be placed on the basis of the area priorities shown in FIG. 7a when a manufactured vehicle is stored and placed, and can also select a parking area where a manufactured vehicle is to be dispatched or relocated on the basis of the area priorities shown in FIG. 7b when a manufactured vehicle is relocated or dispatched.

For example, manufactured vehicles can be stored and dispatched through one entrance/exit shown in FIGS. 7a to 7b. When the area priorities of a plurality of parking areas are set the same, there may be a problem of congestion at the entrance/exit when manufactured vehicles are stored or dispatched. Accordingly, the priority setting part 240 can set area priorities such that the area priority considered when manufactured vehicles are stored and the area priority considered when manufactured vehicles are dispatched are different, in order to prevent congestion. As a result, the congestion issue at the entrance/exit can be minimized, and efficient path setting can be achieved when setting storage and dispatch paths for vehicles to be described below.

Referring again to FIG. 6, the path selection part 250 can create control information to be provided to at least one smart logistics vehicle on the basis of the information about the parking area selected by the priority setting part 240 For example, when a manufactured vehicle is placed, the path selection part 250 collects information about one parking area selected by the priority setting part 240 where a manufactured vehicle will be placed, and can collect the current location information of at least one smart logistics vehicle from the communication part 114 of the smart logistics vehicle 110.

The path selection part 250 can determine the travel distance or travel time between each of a plurality of smart logistics vehicles and one selected parking area on the basis of the information collected from the priority setting part 240 and the communication part 114 of the smart logistics vehicle 110. In this case, the path Selection part 250 can determine the travel distance or travel time from a departure point through a waypoint to a destination, with the current location of each of the plurality of smart logistics vehicles as a departure point, the location of a manufactured vehicles as a waypoint, and one parking area selected by the priority setting part 240 as a destination. Further, the path selection part 250 can create control information for at least one smart logistics vehicle so that the manufactured vehicle is placed in the one parking area selected by the priority setting part 240 by at least one smart logistics vehicle having the shortest travel distance or minimum travel time among the determined travel distances or travel times. In this case, the control information may be travel path information from a departure point to a destination.

Further, when a transport assisting device 170 is present between a departure point and a waypoint or between a waypoint and a destination, the path selection part 250 may collect information about the operating state from the transport assisting device 170 and may also determine the travel distance or travel time from the departure point through the waypoint to the destination in consideration of the operating state of the transport assisting device 170.

As another embodiment, when a manufactured vehicle is relocated, the path selection part 250 can create a path for relocation of each of one or more vehicles to be relocated, on the basis of information about one or more relocation target vehicles selected by the priority setting part 240 and a parking area in which each of the one more relocation vehicles are to be relocated. For example, the path selection part 250 can create a path for relocating any one relocation target vehicle corresponding to the highest dispatch order among the dispatch priorities of one or more relocation target vehicles to a dispatch staging area corresponding to the highest area order among the area priorities of a plurality of parking areas. To this end, the path selection part 250 can collect location information of each of a plurality of smart logistics vehicles from the communication part 114 of the smart logistics vehicle 110.

The path selection part 250 can determine a travel distance or travel time between each of the plurality of smart logistics vehicles and a parking area to which each of one or more relocation target vehicles is to be relocated, on the basis of the collected information. In this case, the path selection part 250 can determine a travel distance or travel time from a departure point through waypoint to a destination, with the current location of each of the plurality of smart logistics vehicles as a departure point, a parking area in which a different one of the one or more relocation target vehicles is located as a waypoint, and a parking area selected for each of the one or more relocation target vehicles as a destination.

Further, the path selection part 250 can create control information for at least one smart logistics vehicle so that the at least one relocation target vehicle is placed in the parking area selected for the at least one relocation target vehicle by at least one smart logistics vehicle having the shortest travel distance or minimum travel time among the determined travel distances or travel times. In this case, the control information may be travel path information from a departure point to a destination. Further, the path selection part 250 may create control information such that the travel paths of smart logistics vehicles 110 located at least near each other do not overlap in order to prevent congestion among smart logistics vehicles 110. However, this is exemplary and the present disclosure is not necessarily limited thereto.

Further, the path selection part 250 may create control information for at least one smart logistics vehicle such that a manufactured vehicle relocated in the dispatch staging area is dispatched. In the case of dispatch of a manufactured vehicle, the path selection part 250 can perform the dispatch similarly to the placement or relocation of a manufactured vehicle described above. For example, in the case of dispatch of a manufactured vehicle, a manufactured vehicle in the dispatch staging area may be dispatched first. To this end, the path selection part 250 determines the current location of at least one smart logistics vehicle among a plurality of smart logistics vehicle, and determines a travel distance or travel time from a departure point through a waypoint to a destination with the current position of the at least one smart logistics vehicle as a departure point, the dispatch staging area as a waypoint, and the dispatch area of a manufactured vehicle as a destination, thereby being able to determine movement paths. Further, when a transport assisting device 170 is present between a departure point and a waypoint or between a waypoint and a destination, the path selection part 250 may collect information about the operating state from the transport assisting device 170 and may also determine the travel distance or travel time from the departure point to the destination via the waypoint in consideration of the operating state of the transport assisting device 170.

The path selection part 250 may create control information for at least one smart logistics vehicle such that a manufactured vehicle placed in the dispatch staging area by at least one smart logistics vehicle having the shortest travel distance or minimum travel time among the determined travel distances or travel times. Further, when a transport assisting device 170 is present between a departure point and a waypoint or between a waypoint and a destination, the path selection part 250 may call the transport assisting device 170 for smooth dispatch.

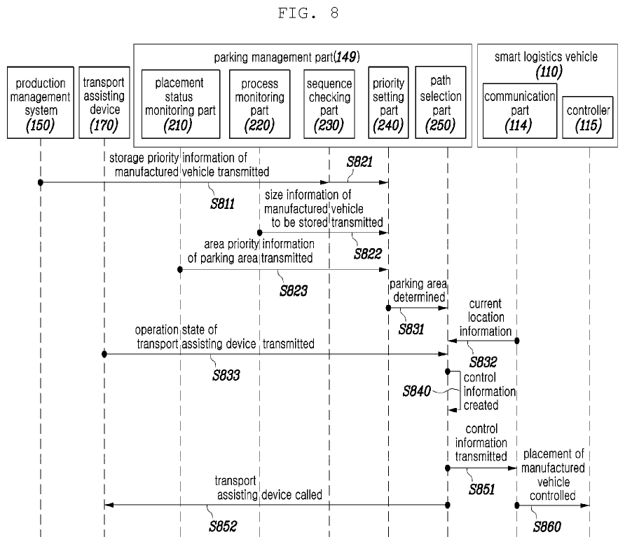

Hereafter, a control method using the control system for the smart factory 100 of FIG. 5 to FIG. 6 described above is described with reference to FIG. 8 to FIG. 10. However, referring to FIG. 5, since the control method for the smart factory of the present disclosure is performed at the parking management part 149 of the control device 140 on the basis of information provided from the smart logistics vehicle 110, the production management system 150, the dispatch management system 160, and the transport assisting device 170, so a control method through the parking management part 149 is described with reference to FIG. 8 to FIG. 10.

Further, the communication part 146 is omitted in FIG. 8 to FIG. 10 because the process that is performed at the parking management part 146 is mainly described, but, as described above with reference to FIG. 5 to FIG. 6, it should be understood that information provision to the parking management part 149 or control information transmission from the parking management part 149 is performed through the communication part 146.

FIG. 8 to FIG. 10 are diagrams illustrating a control method for a smart factory according to an embodiment of the present disclosure.

First, a control method for the smart factory 100 for placing a manufactured vehicle is described with reference to FIG. 8.

Referring to FIG. 8, the production management system 150 can transmit the storage priority according to manufacturing sequence information of a manufactured vehicle to the sequence checking part 230 of the parking management part 149 (S811). Further, the sequence checking part 230 can transmit the storage priority of the manufactured vehicle to the priority setting part 240, the process monitoring part 220 can measure the size of the manufactured vehicle and transmit the size information to the priority setting part 240, and the placement status monitoring part 210 can transmit information acquired by monitoring a plurality of parking areas to the priority setting part 240 (S821, S822, and S823).

The priority setting part 240 of the parking management part 149 can select a parking area, in which the manufactured vehicle is to be placed, from the plurality of parking areas on the basis of the provided information, and can provide the information about the selected parking area to the path selection part 250 (S831). Further, the communication part 114 of each of a plurality of smart logistics vehicles can provide the current location information to the path selection part 250 (S832). Further, the transport assisting device 170 may provide operation state information to the path selection part 250 (S833).

The path selection part 250 can determine the travel distance or travel time of each of the plurality of smart logistics vehicles on the basis of the provided information, and can create a travel path having a shortest travel distance or a minimum travel time among the determined travel distances or travel times as control information for at least one smart logistics vehicle (S840). The process of creating a travel path is the same as the process described above in relation to the path selection part 250 with reference to FIG. 6, so a detailed description is omitted.

The parking management part 149 can transmit the control information created by the path selection part 250 to the communication part 114 of the at least one smart logistics vehicle (S851). Further, when the transport assisting device 170 is present in the travel path of the at least one smart logistics vehicle, the parking management part 149 may call the transport assisting device 170 (S852). Two steps S851 and S852 are sequentially performed in accordance with an embodiment in FIG. 8, but the present disclosure is not necessarily limited thereto. For example, step S852 of calling the transport assisting device 170 of two steps S851 and S852 may be performed earlier than step S851 of transmitting the control information to the communication part 114, or steps S851 and S852 may be performed simultaneously.

The communication part 114 transmits a control instruction to the controller 115 and the controller 115 can control the smart logistics vehicle 110 to place the manufactured vehicle on the basis of the control instruction (S860).

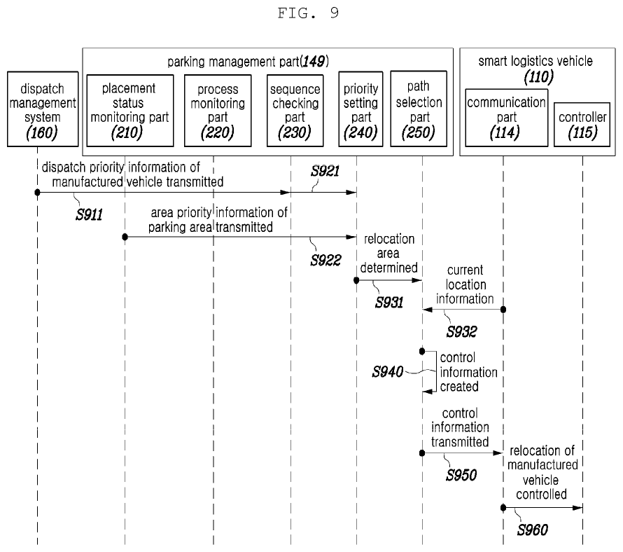

Next, the control method for the smart factory 100 according to dispatch of a vehicle is described with reference to FIG. 9.

Referring to FIG. 9, the dispatch management part 160 can provide a dispatch priority of a manufactured vehicle according to a customer delivery request to the sequence checking part 230 of the parking management part 149. Further, the sequence checking part 230 can provide the dispatch priority to the priority setting part 240 and the placement status monitoring part 210 can provide monitoring information about parking areas in which manufactured vehicles are placed to the priority setting part 240 (S921, S922). The priority setting part 240 can select at least one relocation target vehicle, which needs to be relocated, from the manufactured vehicles placed in a plurality of parking areas in consideration of dispatch priorities and area priorities on the basis of the provided information, and can select a parking area in which the at least one relocation target vehicle is to be relocated from the plurality of parking areas. Further, the priority setting part 240 can transmit the information about the selected at least one relocation target vehicle and the parking area corresponding to the at least one relocation target vehicle to the path selection part 250 (S931).

The communication part 114 of each of a plurality of smart logistics vehicles can provide the current location information to the path selection part 250 (S932). The path selection part 250 can determine the travel distance or travel time of each of the plurality of smart logistics vehicles on the basis of the provided information, and can create a travel path having a shortest travel distance or a minimum travel time among the determined travel distances or travel times as control information for at least one smart logistics vehicle (S940). The process of creating a travel path is the same as the process described above in relation to the path selection part 250 with reference to FIG. 6, so a detailed description is omitted.

Thereafter, the parking management part 149 can transmit the created information to the communication part 114 of the at least one smart logistics vehicle (S950), and the communication part 114 receiving the control information of the smart logistics vehicle 110 transmits the path to the controller 115, and the controller 115 can control the smart logistics vehicle 110 to relocate the manufactured vehicle on the basis of the control information (S960).

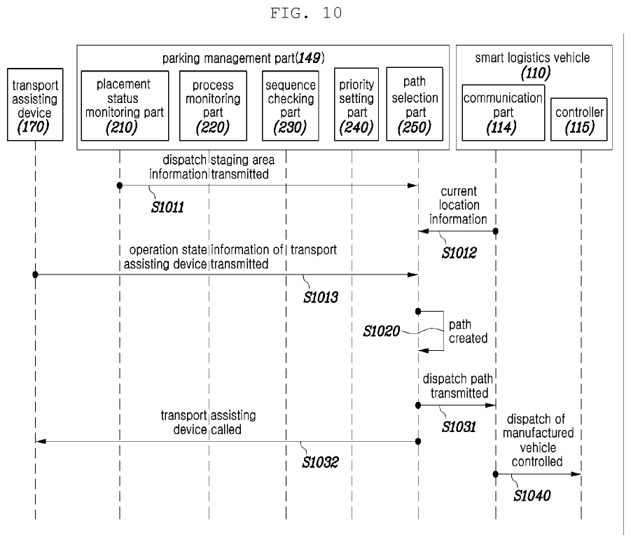

Next, the control method for the smart factory 100 according to dispatch of a manufactured vehicle is described with reference to FIG. 10.

Referring to FIG. 10, the placement status monitoring part 210 of the parking management part 149 can transmit the information about the dispatch staging area of a plurality of parking area to the path selection part 250 (S1011). Further, path selection part 250 can collect current location information from the communication part 114 of each of a plurality of smart logistics vehicles (S1012). Further, when the transport assisting device 170 is present in the travel paths of smart logistics vehicles, the path selection part 250 can receive the operation state information from the transport assisting device 170 (S1013).

The path selection part 250 of the parking management part 149 can create a path for dispatching a manufactured vehicle placed in the dispatch staging area on the basis of the provided information (S1020). The process of creating a travel path is the same as the process described above in relation to the path selection part 250 with reference to FIG. 6, so a detailed description is omitted.

The path selection part 250 can determines a travel path having a shortest travel distance or a minimum travel time among the determined travel distances or travel times, and can transmit the determined travel path to at least one smart logistics vehicle as control information (S1031). Further, when a transport assisting device 170 is present between a departure point and a waypoint or between a waypoint and a destination, the path selection part 250 may call the transport assisting device 170 for smooth dispatch (S1032). Two steps S1031 and S1032 are sequentially performed in accordance with an embodiment in FIG. 10, but the present disclosure is not necessarily limited thereto. For example, step S1032 of calling the transport assisting device 170 of two steps S1031 and S1032 may be performed earlier than step S1031 of transmitting the control information to the communication part 114, or steps S1031 and S1032 may be performed simultaneously.

The communication part 114 receiving the control information from the parking management part 149 can provide the control information to the controller 115. The controller 11 can control at least one smart logistic vehicle to dispatch the manufactured vehicle placed in the dispatch staging area on the basis of the provided control information (S1040).

By placing manufactured vehicles on the basis of the storage priorities of the manufactured vehicle or the area priorities of parking areas when manufactured vehicles are stored, or relocating manufactured vehicles on the basis of the dispatch priorities of manufactured vehicles or the area priorities of parking areas through the control device for a smart factory according to an embodiment of the present disclosure, it is possible to efficiently store/dispatch manufactured vehicles using at least one of a plurality of smart logistics vehicles.

Although the present disclosure was provided above in relation to specific embodiments shown in the drawings, it is apparent to those skilled in the art that the present disclosure may be changed and modified in various ways without departing from the scope of the present disclosure, which is described in the following claims.

The present disclosure can be achieved as computer-readable codes in a program-recoded medium. A computer-readable medium includes all kinds of recording devices that keep data that can be read by a computer system. For example, the computer-readable medium may be an HDD (Hard Disk Drive), an SSD (Solid State Disk), an SDD (Silicon Disk Drive), a ROM, a RAM, a CD-ROM, a magnetic tape, a floppy disk, and an optical data storage. Accordingly, the detailed description should not be construed as being limited in all respects and should be construed as an example. The scope of the present disclosure should be determined by reasonable analysis of the claims and all changes within an equivalent range of the present disclosure are included in the scope of the present disclosure.

### DESCRIPTION OF REFERENCE NUMERALS

100: smart factory
110: smart logistics vehicle
120: manufacturing device
130: monitoring device
140: control device

1. A control method of a smart factory, comprising:
determining area priorities for a plurality of parking areas;
placing a manufactured vehicle to one parking area of the plurality of parking areas based on storage priorities according to manufacturing sequence information of a production management system and the area priorities; and
relocating at least one of manufactured vehicles placed in the plurality of parking areas based on dispatch priorities according to customer delivery order information of a dispatch management system and the area priorities.

2. The control method of claim 1, wherein the area priorities are set in advance for the plurality of parking areas, respectively based on distances between an entrance and exit of a space, in which the plurality of parking areas is provided, and the plurality of parking areas.

3. The control method of claim 2, wherein the area priorities are set to be different in the placing the manufactured vehicle and the relocating the manufactured vehicle.

4. The control method of claim 1, wherein the placing comprises:
selecting one parking area, in which the manufactured vehicle is to be placed, from the plurality of parking areas based on the storage priorities and the area priorities; and
placing the manufactured vehicle to the selected one parking area using at least one of a plurality of smart logistics vehicles.

5. The control method of claim 4, wherein the placing comprises:
determining a travel distance or a travel time between each of the plurality of smart logistics vehicles and the selected on parking area; and
placing the manufactured vehicle to the selected one parking area using at least one smart logistics vehicle having a shortest travel time or a minimum travel time among the determined travel distances or travel times.

6. The control method of claim 5, wherein the determining the travel distance or the travel time comprises:
collecting current location information of each of the plurality of smart logistics vehicles; and
determining a travel distance or a travel time from a departure point through a waypoint to a destination with the current location of each of the plurality of smart logistics vehicles as the departure point, a location of the manufactured vehicle as the waypoint, and the selected on parking area as the destination.

7. The control method of claim 6, wherein the determining the travel distance or the travel time comprises determining a travel distance or a travel time from the departure point through the waypoint to the destination in consideration of an operation state of a transport assisting device when the transport assisting device is present between the departure point and the waypoint or between the waypoint and the destination.

8. The control method of claim 7, wherein the transport assisting device comprises at least one of a smart automatic door device, and a lift and an elevator that move between floors.

9. The control method of claim 1, wherein the relocating comprises:
selecting one or more relocation target vehicles, which need to be relocated, from manufactured vehicles placed in the plurality of parking areas based on the dispatch priorities and the area priorities;
selecting parking areas, in which the one or more relocation target vehicles are to be placed, respectively, from the plurality of parking areas based on the dispatch priorities and the area priorities; and
placing the relocation target vehicles to the selected parking areas, respectively, using at least one of a plurality of smart logistics vehicles.

10. The control method of claim 9, wherein the selecting the one or more parking areas comprises
selecting parking areas corresponding to area priorities, which match dispatch priorities of the one or more relocation target vehicles, respectively, from the plurality of parking areas.

11. The control method of claim 9, wherein the relocating comprises relocating any one relocation target vehicle among the one or more relocation target vehicles to a dispatch staging area corresponding to a highest area order among the plurality of parking areas when a dispatch priority of the any one relocation target vehicle corresponds to a highest dispatch order.

12. The control method of claim 9, wherein the relocating comprises:
collecting current location information of each of the plurality of smart logistics vehicles;
determining a travel distance or a travel time from a departure point through a waypoint to a destination with the current location of each of the plurality of smart logistics vehicles as the departure point, a parking area, in which a different one of the one or more relocation target vehicles is placed, as the waypoint, and a parking area selected for each of the relocation target vehicles as the destination; and
relocating the one or more relocation target vehicles to the selected parking areas, respectively, using at least one smart logistics vehicle having a shortest travel time or a minimum travel time among the determined travel distances or travel times.

13. The control method of claim 9, further comprising dispatching a manufactured vehicle relocated in the dispatch staging area using at least one of the plurality of smart logistics vehicles after the relocating.

14. A control device for a smart factory, comprising:
a parking management part configured to determine area priorities for a plurality of parking areas and configured to create control information for at least one smart logistics vehicle such that a manufactured vehicle is placed in one parking area of the plurality of parking areas based on storage priority according to manufacturing sequence information of a production management system and the area priorities or such that at least one of manufacture vehicles placed in the plurality of parking areas is relocated based on dispatch priority according to customer delivery information of a dispatch management system and the area priorities; and
a communication part configured to transmit the control information to the at least one smart logistics vehicle.

15. The control device of claim 14, wherein the parking management part is configured to select one parking area, in which the manufactured vehicle is to be placed, from the plurality of parking areas based on the storage priorities and the area priorities, and is configured to create control information for the at least one smart logistics vehicle such that the manufactured vehicle is placed in the selected one parking area.

16. The control device of claim 15, wherein the parking management part is configured to determine a travel distance or a travel time between each of the plurality of smart logistics vehicles and the selected one parking area, and is configured to create control information for at least one smart logistics vehicle, which has a shortest travel distance or a minimum travel time among the determined travel distances or travel times, such that the at least one smart logistics vehicle places the manufactured vehicle to the selected one parking area.

17. The control device of claim 16, wherein the parking management part is configured to collect current location information of each of the plurality of smart logistics vehicles, and is configured to determine a travel distance or a travel time from a departure point through a waypoint to a destination with the current location of each of the plurality of smart logistics vehicles as the departure point, a location of the manufactured vehicle as the waypoint, and the selected on parking area as the destination.

18. The control device of claim 14, wherein the parking management part is configured to select one or more relocation target vehicles, which need to be relocated, from manufactured vehicles placed in the plurality of parking areas based on the dispatch priorities and the area priorities; is configured to select parking areas, in which the one or more relocation target vehicles are to be placed, respectively, from the plurality of parking areas based on the dispatch priorities and the area priorities; and is configured to create control information for at least one of a plurality of smart logistics vehicles such that the one or more relocation target vehicles are relocated to the selected parking areas, respectively.

19. The control device of claim 18, wherein when a dispatch priority of any one of the one or more relocation target vehicles corresponds to a highest dispatch order, the parking management part is configured to create control information for at least one of the plurality of smart logistics vehicles such that the any one relocation target vehicle is relocated to a dispatch staging area corresponding to a highest area order among the plurality of parking areas.

20. The control device of claim 18, wherein the parking management part is configured to collect current location information of each of the plurality of smart logistics vehicles; is configured to determine a travel distance or a travel time from a departure point through a waypoint to a destination with the current location of each of the plurality of smart logistics vehicles as the departure point, a parking area, in which a different one of the one or more relocation target vehicles is placed, as the waypoint, and a parking area selected for each of the relocation target vehicles as the destination; and is configured to create control information for the at least one smart logistics vehicle such that the one or more relocation target vehicles are relocated to the selected parking areas, respectively, by at least one smart logistics vehicle having a shortest travel time or a minimum travel time among the determined travel distances or travel times.
